(19) United States
(12) Patent Application Publication
(10) Pub. No.: US 2023/0399167 A1
(43) Pub. Date: Dec. 14, 2023

(54) Recycling Apparatus

(71) Applicant: Tommy L. Patton, Oak Glen, CA (US)

(72) Inventor: Tommy L. Patton, Oak Glen, CA (US)

(21) Appl. No.: 17/835,976

(22) Filed: Jun. 9, 2022

(51) Int. Cl. B65F 1/14; G07F 7/06; B65F 1/16

(52) U.S. Cl. CPC B65F 1/1426; G07F 7/06; B65F 1/1615; B65F 2210/128; B65F 2240/112; B65F 2240/12; B65F 2210/138

(57) ABSTRACT

A recycling apparatus with two methods of recycling items. The apparatus is preferably configured as a kiosk placed within a location such as a store, market or gas station or external to a location. The kiosk has an enclosure including a receiving opening with a lockable door. In the first configuration, bottles or cans are secured onto a recycling strip, which is then inserted through the receiving opening and attached onto a securing means within the enclosure. In the second configuration, a recycling strip is not utilized and the bottles or cans are inserted through the receiving opening, placed on a support platform and then processed into recyclable material. Operating controls or a wireless interface allows control of the operation of the apparatus. Once the bottles or cans are processed, the remaining recyclable material is then removed from the enclosure for transportation to a recycling facility.

### TECHNICAL FIELD

The invention generally pertains to recycling bottles and cans, and more particularly to a recycling apparatus such as a kiosk that facilitates the recycling and further processing of bottles and metal (aluminum) cans.

### BACKGROUND ART

One of the most important considerations in developed and developing countries is the need for strong positive environmental practices. There are multiple actions that contribute to a healthy environment. One of these is recycling, and particularly the recycling of metal (aluminum), plastic or even glass bottles and cans. Both public and private sectors have implemented plans or required actions that encourage recycling. For example, many cities provide residents with color coded receptacles or people to place recyclable item into. While the receptacles have been somewhat successful, there is no feasible way to ensure people are placing recyclable items in the receptacles, nor is there any impetus to do so.

Another action to encourage recycling is to offer a cash redemption value for each bottle or can that is recycled. The problem with this is that in order to receive the redemption value, a person must transport the physical bottles and cans to a recycling center. Unfortunately, many recycling centers are not at the best locations, and are often viewed as dirty places. This is in addition to the fact that recyclable bottles and cans are typically placed in bags, boxes or other containers, and then transported, usually by an individual's personal vehicle, to the recycling center. The entire process can be difficult and time-consuming, not to mention many bottles and cans that are not entirely empty will leaks sticky, semi-liquid mess in the vehicle and on the person who is transporting them. When considering the negatives, the amount of redemption value that is obtained is often considered not worth the effort.

What is needed is a quick, convenient and clean method for an individual, family, friend group or others can recycle bottles ad cans. Optimally, there would be an integrated way of providing transportation (including storing) recyclable bottles and cans, a means of providing the redemption value, and a location that is easy to get to and is clean. The location would preferably be a self-service kiosk structure that is located adjacent or in a frequently used store or other retail space, such as a market, convenience store, gas station or any location that people would travel to as part of their regular schedule. The kiosk would be easy and simple to use, and when combined with a product such as THE BOTTLE STRIP™, which maintains multiple bottles or cans on a single strip of recyclable plastic. would be a significant positive impetus to recycle.

A system that utilizes a kiosk structure that is capable of receiving bottles and cans, preparing the bottles and cans for further processing, and interfacing with both the public (the individuals who recycle) as well as retail stores where the kiosk(s) are located, and even companies that use recyclable item and sell processed recyclable items would be extremely beneficial for any/all parties that are involved or who participate.

A search of the prior art did not disclose any literature or patents that read directly on the claims of the instant invention. However, the following U.S. patents are considered related:

| PATENT NO. | INVENTOR | ISSUED |
|---|---|---|
| 5,671,666 | Wenglar | Sep. 30, 1997 |
| 6,842,596 | Morii, et al | Jan. 11, 2005 |
| 2008/0296374 | Gonen, et al | Dec. 4, 2008 |
| 2014/0012643 | Behrisch | Jan. 9, 2014 |

The 5,671,666 patent discloses a system for recycling cans includes a housing for displaying promotional advertising, a deposit slot for receiving the cans and a discharge system for providing payment for the cans. The system incorporates a rotating drum for receiving the cans and advancing the cans into a conduit where they are then transported to a crusher for compression and storage. A magnet maintains ferrous cans on the drum until they have passed the conduit for separating ferrous cans from non-ferrous, recyclable cans.

The 6,842,596 patent discloses a recycling apparatus, recycling method and recycled product. Information about a recycling item is input, a first sorting condition is prepared so as to sort the recycling item into one of a plurality of groups corresponding to conditions for decomposing the recycling item. A second sorting condition sorts recycling parts, into groups corresponding to material of each of the recycling parts. A third sorting condition sorts the recycling parts into processing groups corresponding to types of recycling processing to be carried out. Finally, the first, second, and the third sorting conditions are transmitted to fields where the recycling item and the recycling parts are sorted.

The 2008/0296374 publication discloses a system and method of providing incentive to recycle materials by providing incentives to consumers for recycling at a recycling kiosk. The method of providing incentive to recycle materials comprises providing a recycling kiosk having a load determining device for receiving a quantity of recyclable materials, obtaining identification data, measuring the quantity of recyclable material received and calculating a reward based on the quantity of recyclable material.

The 2014/0012643 publication discloses methods and systems for encouraging recycling. A central authority receives an indication of items and determines a deposit value for each item based on recyclable materials included in the item. The central authority receives an indication that an item has been sold and receives the deposit value for the item. A message is sent to the central authority when the item has been returned, and the central authority reimburses the deposit value which is used to provide manufacturers of recyclable material an incentive to purchase recycled materials.

For background purposes and indicative of the art to which the invention relates, reference may be made to the following remaining patents found in the patent search.

| PATENT NO. | INVENTOR | ISSUED |
|---|---|---|
| 4,316,533 | Hughes, et al | Feb. 23, 1982 |
| 4,576,289 | Jarrett, et al | Mar. 18, 196 |
| 4,989,507 | Rhoades, et al | Feb. 5, 1991 |
| 5,469,783 | Fry | Nov. 28, 1995 |
| 9,618,160 | Eihusten, et al | Apr. 11, 2017 |
| 9,881,284 | Bowles | Jan. 30, 2018 |
| 10,496,963 | Silva, et al | Dec. 3, 2019 |

### DISCLOSURE OF THE INVENTION

A recycling apparatus that can be used for both plastic bottles or aluminum cans. While the recycling apparatus is designed primarily for bottles or cans, the apparatus could be easy modified/adapted for use with other items, such as glass bottles or electronics such as cellular/wireless telephones. The recycling apparatus can be any size or shape, as determined by the requirements of use and/or preferences of the user optimally, the recycling apparatus will be configured as a kiosk that is either free-stranding or secured to a structure/surface such as a wall. Also, the recycling apparatus can be placed at an outdoor location or within a building such as a store, market or gas station.

For the purpose of this disclosure, the recycling apparatus is disclosed as a square or rectangular kiosk structure with a front surface, a first side surface, a rear surface, a second side surface, an upper surface and a lower surface. Preferably located on the front surface is at least one receiving opening that facilitates the insertion of a recyclable bottle or can on a recycling strip, such as THE BOTTLE STRIP′, into the enclosure. The opening has a door with locking means that are manually operated or electronically controlled. Once a recycling strip with bottles or cans attached is inserted, securing means maintain the strip with bottles or cans positioned within the enclosure.

An electronic control system that is powered by a power source allows the position of the strip to be altered, and to control the overall operation of the apparatus. A scanning and reading device optically scans and reads data, such as a barcode, on the bottles or cans.

Processing means, including crushing or grinding as well as other methods, convert the bottles or cans into a recyclable material. Removal means then remove the recyclable material after processing. Preferably located on the enclosure's front surface are operating controls for externally controlling the operation and functions of the apparatus. The controls can be buttons and a screen, or the control of the apparatus can be achieved by use of a wireless device that works in combination with a wireless interface that allows bi-directional communication between the apparatus and wireless device.

Data recording and management means maintain and manage data collected from the recycling apparatus. The means comprises a central processing unit (CPU), data storage device, and software for controlling the operation of the means.

Located within the enclosure or externally adjacent to the enclosure is a collection hopper for collecting the processed recyclable material. The hopper is basically a container with an open top. Once the hopper is full of recyclable material, the container is removed and the recyclable material transferred to a vehicle or other means for further processing at a plastic or metal facility. The material from the container can either be removed manually by-hand, or a powered device such as a conveyor belt can be utilized to transfer the material from the hopper container to a vehicle or other means.

A second design of the recycling apparatus facilitates the insertion of bottles or cans that are not secured on a recycling strip. The structure and functional elements are essentially the same as the first design, with the exception being that once a bottle or can, or multiple bottles or cans, are inserted into the enclosure via at least one receiving opening, the bottles or cans, are placed on an internal plate. An electronic control system allows the position of the plastic to be altered. From the plate the bottles or cans are transferred to processing means, as with the first design.

In view of the above disclosure the primary objects of the invention to provide a recycling apparatus that allows recyclable items such as plastic bottles or aluminum cans to be quickly and easily taken to a clean and accessible kiosk structure, inserted into the kiosks and then processed for removal to a facility for further recycling processing.

In addition to the primary object, it is also an object of the invention to provide a recycling apparatus that:
is easy to operate,
can generate revenue for both an owner and a user,
is essentially maintenance free,
is robust and long lasting,
can be use indoors or outdoors,
is safe for use by adults and children,
greatly encourages recycling,
can be modified for use with other recyclable items.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an orthogonal front view of are cycling apparatus configured as a kiosk.

FIG. 2 is an elevational front view of a store, with a cut-away section showing a recycling apparatus kiosk within the store.

FIG. 3 is an elevational front view of a store, with a recycling apparatus kiosk located externally, adjacent to the store.

FIG. 4 is an orthogonal front view of the recycling apparatus in a circular configuration.

FIG. 5 is an elevational side view of the recycling apparatus first design configuration, with a cut-away showing the internal components including a bottle strip securing means.

FIG. 6 is an elevational side view of the recycling apparatus second design configuration, with a cut-away section showing the internal components including a support platform for bottles or cans.

### BEST MODE FOR CARRYING OUT THE INVENTION

The best mode for carrying out the invention is presented in terms that disclose a preferred embodiment with two design configurations of are cyclable apparatus. One of the most important issues in the modern world is the environment, and specifically how to protect the environment and provide a safe, healthy plant on which people live. Of all the environmental issues, recycling is a dominant concern. People produce a large amount of waste, some of which can be reused, sometimes many times. There have been serious efforts to encourage (or in some cases mandate) people to recycle. These include celebrity advocates, government instructions, and one of the oldest methods, a cash redemption value for each recyclable bottle or can that is taken to a recycle facility.

Even with all the incentives, including the cash redemption, many people still do not recycle. They are multiple reasons for this, some of which are, it is difficult to save and transport bottles and cans to a recycling facility. Handling empty bottles and cans is often a messy, sticky undertaking, and the recycling facilities are viewed as dirty places many people prefer not to visit.

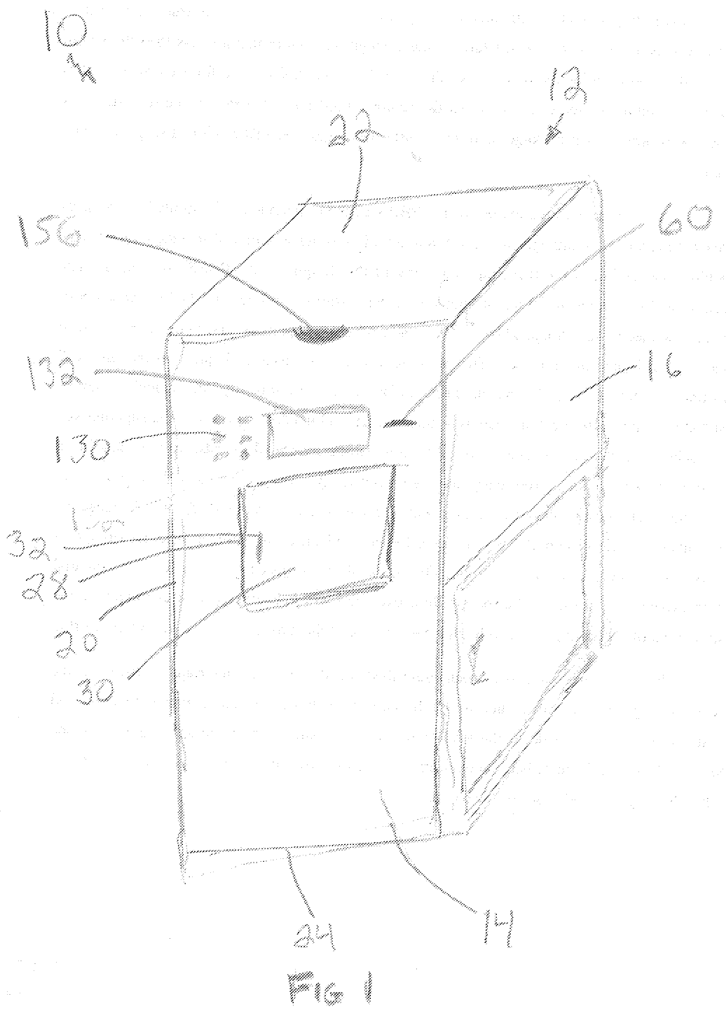

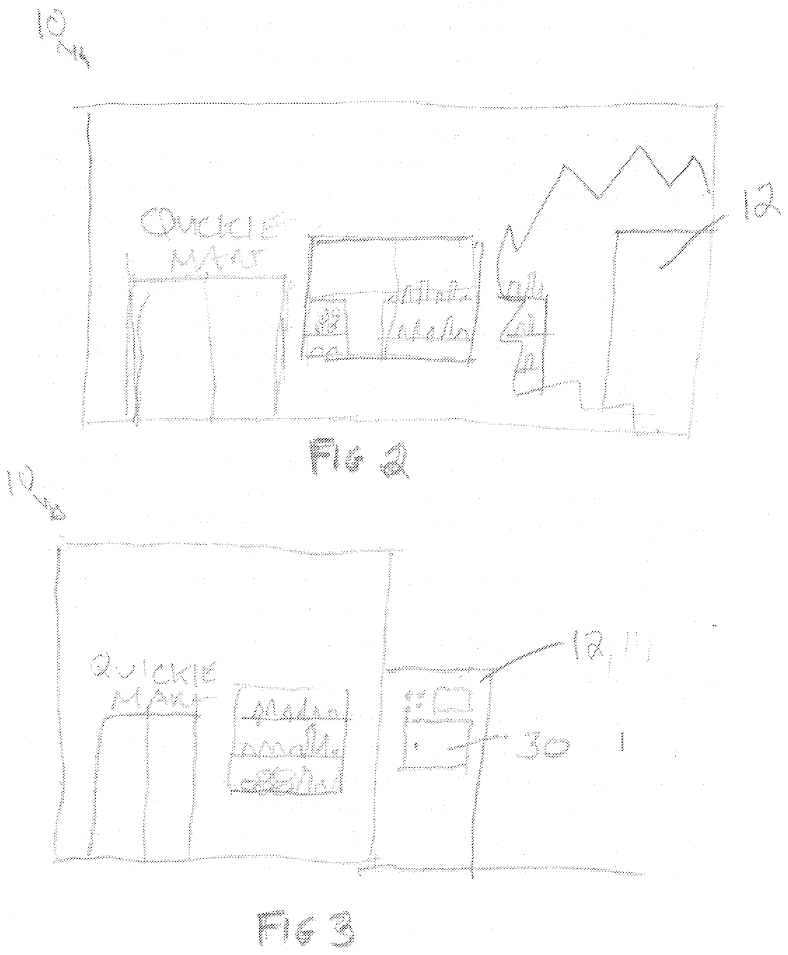

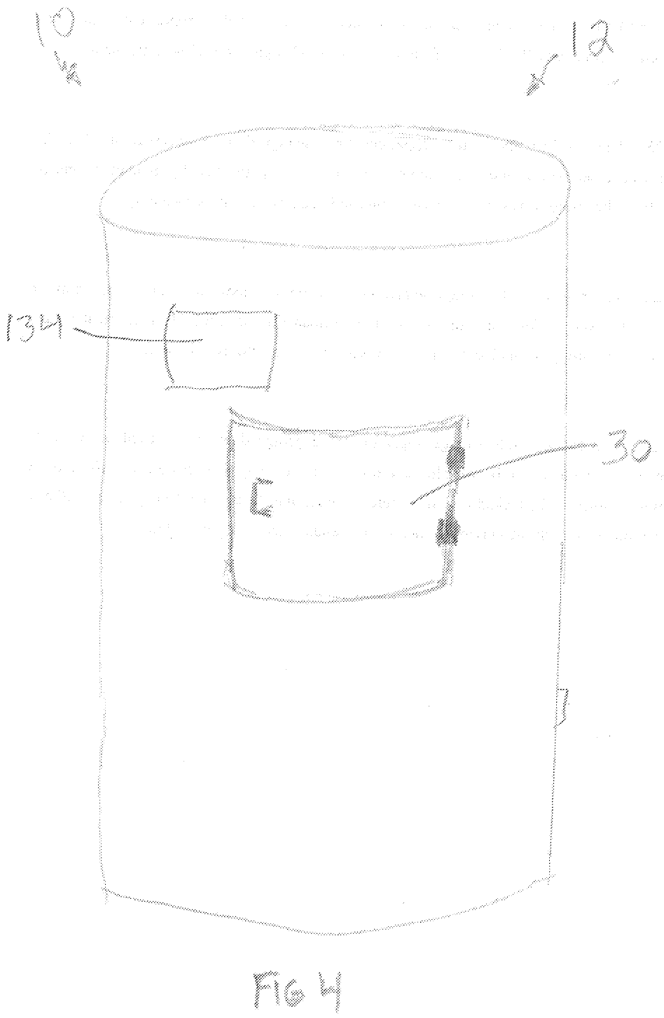

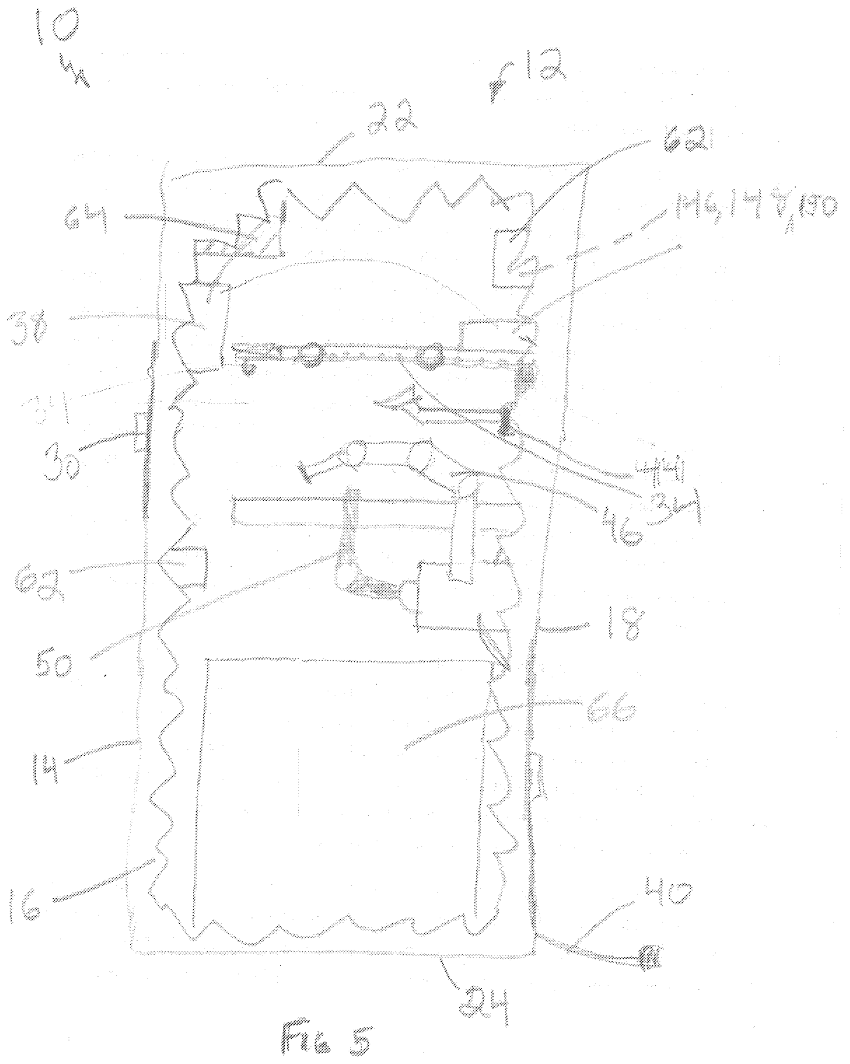

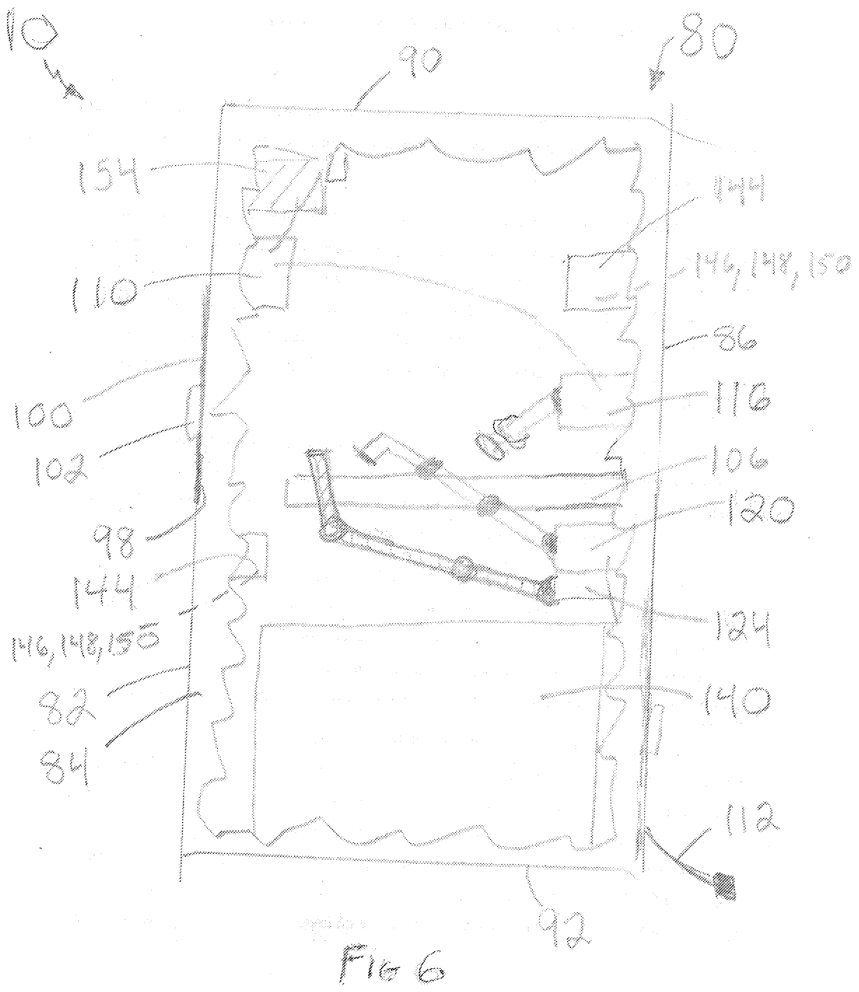

The recycling apparatus 10, as shown in FIGS. 1-6, provides a solution to the above problem and reasons. The recycling apparatus is designed to be used in combination with a recycling strip, such as The Bottle Strip™ or for individual bottles or cans. The recycling apparatus is preferably configured as a kiosk and is preferably square shaped, as shown in FIGS. 1, 5 and 6. Although other shapes such as circular, as shown in FIG. 4 could also be utilized. The recycling apparatus 10 kiosk can be made of various materials such as plastic, metal, wood or a composite, with the type of material dependent on whether the apparatus kiosk is placed within a location such as a store, market or gas station, or if the apparatus kiosk is placed externally adjacent to a location such as a store or even next to a gas pump.

The first design configuration of the recycling apparatus 10, as shown in FIGS. 1-3, and 5, is configured to be used in combination with a recycling strip such as The Bottle Strip™. The first design configuration is comprised of an enclosure 12 with a front surface 14, a first side surface 16, a rear surface 18, a second side surface 20, an upper surface 22, and a lower surface 24. It should be noted these elements listed above are for a square-shaped recycling apparatus, which for the purpose of this disclosure will be described and shown in FIGS. 1-3 and 5. As previously disclosed the recycling apparatus can be other shapes such as circular, as shown in FIG. 4, with the shape determined by the requirements of use and desire of the owner/user.

Located preferably on the enclosure's front surface 14 is at least one recycling opening 28 that facilitates the insertion of a recyclable item such as a plastic bottle or aluminum can a recycling strip into the enclosure. A door 30 with locking means 32 covers the receiving opening 28. The door's locking means can either be manual/by-hand or electronically controlled. It is important that the locking means are always engaged while the recycling apparatus 10 is in operation. This ensures the prevention of injuries occurring if a person accidentally (or otherwise) reaches their hand/arm into the receiving opening while the recycling apparatus is operating. While the recycling apparatus is primarily designed for recycling plastic bottles or aluminum cans, it would not be difficult to modify the design to allow the recycling of other items such as glass bottles or even wireless telephones (or other electronics).

Located within the enclosure 12 adjacent the receiving opening 28, is securing means 34 for maintaining the recycling strip with recyclable items positioned within the enclosure 12. Typically, a recycling strip will be maintained on the securing means by a hook clamp or other similar device. An electronic control system 38 that is powered by a power source 40 allows the position of the recycling strip to be altered, as well as control the operation of the recycling apparatus. The power source 40 can be utility main power, battery power or solar power, or a combination such as battery power with utility main power as a back-up power source.

A scanning and reading device 44, such as an optical scanner is utilized to scan and read data on the recyclable items. The data typically comprises manufacturing information, product information, or information accessed via a barcode or QR code. Processing means 46 are used to convert the recyclable bottles or cans into a recyclable material. Although there can be many types of processing means 46, some of the most effective include binding, chipping, crushing, shredding or pulverizing.

After the recyclable bottles or cans have been processed, the remaining recyclable material is removed by removal means 50. As with the processing means, there can be various types of removal means including manual, by-hand removal, as conveyor belt, a vacuum, pressurized air (either pushing or pulling), a screw auger or a pull plug.

External control of the operation and functions of the recycling apparatus is accomplished by operating controls 52. Preferably located on the enclosures front surface 14, adjacent the receiving opening 28, the operating controls comprise either buttons 54 and a screen 56, as shown in FIG. 1, or a touchscreen (TFT) 58 only, as shown in FIG. 4. Data recording and management means 62 are used to maintain and manage data selected from the recycling apparatus The data recording and management means 62 comprises a central processing unit (CPU) 146, a data storage device 148 such as a hand-drive, and software 150 for controlling the operation of the data recording and management means 62. The data that is collected can include personal data of a person utilizing the recycling apparatus, information pertaining to the items being recycled and/or financial information pertaining to redemption values of the recycled items. Also, near the operating controls is a slot 60, as shown in FIG. 1, out of which a printed receipt or other printed information can be supplied to a user, or owner of the apparatus 10. For the user, a receipt can show how many bottles or cans were inserted into the apparatus, and how much cash redemption the user will receive, or there can be coupons and other promotional information a person will receive after recycling their bottles or cans. For an owner/operator of the apparatus, the slot 60 can output printed usage information and/or diagnostic data if the apparatus is not functioning correctly.

Either in addition to the operating controls 52, or in lieu of the operating controls, a wireless interface 64 can provide bi-directional communication between the recycling apparatus, including all functionality, and a wireless device such as a smart phone. Preferably, an app will be used to facilitate this. Per current technology, the wireless interface will operate via WiFi or Bluetooth connectivity.

After the bottles or cans have been processed, the remaining recyclable material is collected into a collection hopper 66. The hopper 66 is comprised of a basket or barrel that is located either within the enclosure, at the bottom, below the operational components, or externally adjacent to the enclosure. When the hopper 16 is within the enclosure 12, an opening with a lockable door allows the hopper to be accessed, and then removed to empty the contents, or replaced once the contends have been removed. When the hopper 66 is external to the enclosure, a transfer means such as a slide member, conveyor belt or similar device is used to transport the recyclable material from the enclosure to the hopper. As a final, functional assistance, particularly when the apparatus is located outside and used at night, a light 156, as shown in FIG. 1, can be placed on the enclosure to provide illumination to the controls and other operational elements.

The second design configuration of the recycling apparatus, as shown in FIG. 6, is essentially the same as the first design configuration with the single exception being that the second design configuration does not utilize or function in combination with a recycling strip. Rather, bottles or cans can be individually inserted through a receiving opening 98 having a door 100 with a lock 102, into the enclosure 80. In lieu of a securing means 34, the second design configuration has an internal support platform 106 on which the bottles or cans are placed. The platform can be various sizes and shapes with a square or circular, flat or concave platform preferred. Other than this difference the second design configuration utilizes the same elements including an electronic control system 120 with a power source 112, scanning and reading device 126, processing means 120, removal means 124, operating controls 128, data storage a management means 144, a wireless interface 154, and a collection hopper 140.

It is important to consider there are multiple possibilities for generating revenue or other financial gains from the recycling apparatus. For example, an individual or company who supplies the recycling apparatus for use at various locations effectivity could control the supply of PET recyclable material and aluminum material which are openly sold on markets worldwide. Additionally, there could be advertising or other promotional items from the apparatus. This could include incentive advertising on the enclosure that compels a user to purchase a product or use a service.

While the invention has been described in detail and pictorially shown in the accompanying drawings it is not to be limited to such details, since many changes and modifications may be made to the invention without departing from the spirit and the scope thereof. Hence, it is described to cover any and all modifications and forms which may come within the language and scope of the claims.

1. A recycling apparatus comprising:
an enclosure having:
a front surface,
a first side surface
a rear surface,
a second side surface,
an upper surface,
a lower surface,
at least one receiving opening that facilities the insertion of recyclable items on a recycling strip into the enclosure, the opening having a door with locking means,
securing means for maintaining the recycling strip with recyclable items positioned within the enclosure,
an electronic control system powered by a power source, the control system allowing the position of the recycling strip to be altered, and to control the operation of the recycling apparatus,
a scanning and reading device to optically scan and read data on the recyclable items,
processing means for converting the recyclable items into a recyclable material,
removal means for removing the recyclable material that is left after the items have been processed,
operating controls for externally controlling the operation and functions of the recycling apparatus,
data recording and management means for maintaining and managing data collected from the recycling apparatus, the data recording and management means comprising a central processing unit (CPU), a data storage device and software for controlling the operation of the data recording and management means,
a wireless interface that allows bi-directional communication between the recycling apparatus and a wireless device, and
a collection hopper that is located within the enclosure or externally adjacent to the enclosure, the hopper collects the recyclable material after the recyclable items have been processed.

2. The recycling apparatus of claim 1, wherein the enclosure is made of a material that is selected from the group consisting of metal, plastic, wood and a composite.

3. The recycling apparatus of claim 1, wherein the enclosure is free-standing.

4. The recycling apparatus of claim 1, wherein the enclosure is attached to or placed adjacent to a second structure.

5. The recycling apparatus of claim 1, wherein the recyclable item is comprised of a plastic bottle.

6. The recycling apparatus of claim 1, wherein the recyclable item is comprised of an aluminum can.

7. The recycling apparatus of claim 1, wherein the receiving opening door is selected from a group consisting of a sliding door, a hinged door and a folding door.

8. The recycling apparatus of claim 1, wherein the receiving opening door lock is manually operated or electronically controlled.

9. The recycling apparatus of claim 1, wherein the securing means for maintaining the recycling strip with recyclable bottles or cans positioned within the enclosure is comprised of a hook or a clamp.

10. The recycling apparatus of claim 1, wherein the electronic control system and operational components power source is selected from a group consisting of utility power, battery power and solar power.

11. The recycling apparatus of claim 1, wherein the scanning and reading device is comprised of an optical scanner or camera.

12. The recycling apparatus of claim 1, wherein the processing means for converting the recyclable bottles into a recyclable material is selected from a group consisting of grinding, chipping, crushing and shredding.

13. The recycling apparatus of claim 1, wherein the removal means for removing the recyclable material that is left after the bottles and cans have been processed is comprised of manual removal by hand, a conveyor belt, a vacuum, pressurized air and a screw auger.

14. The recycling apparatus of claim 1, wherein the operating controls are selected from a group consisting of a plurality of buttons, a viewing screen and a touchscreen.

15. The recycling apparatus of claim 1, wherein the data collected by the recycling apparatus is comprised of personal data pertaining to the user and recycling value amounts that are owed to a user based on the number of bottles or cans that are cycled at the apparatus.

16. The recycling apparatus of claim 1, wherein the collection hopper is placed within or externally adjacent to the recycling apparatus.

17. The recycling apparatus of claim 1, wherein the wireless interface comprises Bluetooth connectivity.

18. A recycling apparatus comprising:
an enclosure having:
a front surface,
a first side surface,
a rear surface
a second side surface,
an upper surface,
a lower surface,
at least one receiving opening that facilitates the insertion of a recyclable item into the enclosure, the opening having a door with locking means,
an internal support platform on which inserted recyclable items are placed,
an electronic control system powered by a power source, the control system allowing the position of the internal plate to be altered and to control the operation of the recycling apparatus,
a scanning and reading device to optically scan and read data on the recyclable bottles and cans,
processing means for converting the recyclable bottles and cans into a recyclable material,
removal means for removing the recyclable material that is left after the bottles and can have been processed,
operating controls for externally controlling the operation of the recycling apparatus,
data recording and management means for maintaining and managing data collected from the recycling apparatus, the data recording and management means comprising a central processing unit (CPU), a data storage device and software for controlling the operation of the data recording and management means,
a wireless interface that allows bi-directional communication between the recycling apparatus and a wireless device, and
a collection hopper for collecting the processed and removed recyclable material from the recycling apparatus.

19. The recycling apparatus of claim 18, wherein the enclosure is made of a material that is selected from the group consisting of metal, plastic, wood and a composite.

20. The recycling apparatus of claim 18, wherein the enclosure is free-standing.

21. The recycling apparatus of claim 18, wherein the enclosure is attached to a second structure.

22. The recycling apparatus of claim 18, wherein the recyclable item is comprised of a plastic bottle.

23. The recycling apparatus of claim 18, wherein the recyclable item is comprised of an aluminum can.

24. The recycling apparatus of claim 18, wherein the receiving opening door is selected from a group consist of a sliding door, a hinged door and a folding door.

25. The recycling apparatus of claim 18, wherein the receiving opening door lock is manually operated or electronically controlled.

26. The recycling apparatus of claim 18, wherein the internal support platform is comprised of a substantially flat or concave structure on which bottles or cans lay after being inserted through the receiving opening.

27. The recycling apparatus of claim 18, wherein the electronic control system and operational components power source is selected from a group consisting of utility power, battery power and solar power.

28. The recycling apparatus of claim 18, wherein the processing means for converting the recyclable bottles into a recyclable material is selected from a group consisting of grinding, chipping, crushing and shredding.

29. The recycling apparatus of claim 18, wherein the removal means for removing the recyclable material that is left after the bottles and cans have been processed is selected from a group consisting of manual removal by hand, conveyor belt, a vacuum, pressurized air, and a screw auger.

30. The recycling apparatus of claim 18, wherein the operating controls are selected from a group consisting of a plurality of buttons, a viewing screen or a touchscreen.

31. The recycling apparatus of claim 18, wherein the collection hopper is placed within or externally adjacent to the recycling apparatus.

32. The recycling apparatus of claim 18, wherein the wireless interface comprises Bluetooth connectivity.

33. The recycling apparatus of claim 18, wherein the data collected by the recycling apparatus is comprised of personal data pertaining to the user and recycling value amounts that are owed to a user based on the number of bottles or cans that are recycled at the apparatus.
